(19) United States
(12) Patent Application Publication
(10) Pub. No.: US 2014/0366978 A1
(43) Pub. Date: Dec. 18, 2014

(54) Pipe Support Device

(71) Applicant: Smed T Kristiansen AS, Stavanger (NO)

(72) Inventor: Svein Westlund Kristiansen, Randaberg (NO)

(73) Assignee: SMED T KRISTIANSEN AS, Stavanger (NO)

(21) Appl. No.: 14/374,129

(22) PCT Filed: Feb. 13, 2013
(86) PCT No.: PCT/NO2013/050030

§ 371 Date: Jul. 23, 2014

(30) Foreign Application Priority Data
Feb. 17, 2012 (NO) 20120166

(51) Int. Cl. F16L 3/223

(52) U.S. Cl. CPC F16L 3/223
USPC 138/106

(57) ABSTRACT

A pipe support device is for relieving a pipeline. The pipe support includes a bracket arranged to be fixed to a base and a relieving, element. The surface of the relieving element faces the pipeline in the position of application and is formed with a radius of curvature adapted to the outer radius of curvature of the pipeline. The curved surface of the relieving element is formed with a plurality of recesses, whereby a plurality of slots is provided between the pipeline and the relieving element in the position of application of the relieving element.

The invention relates to a pipe support device. More specifically, the invention relates to a pipe support device, the pipe support including a bracket arranged to be fixed to a base, and a relieving element arranged to be fixed to the bracket, the relieving element being formed with an arched surface adapted for a pipe which is to be relieved.

In the first instance, the object of the invention is to extend the life of a pipeline by reducing wear and corrosion at contact/relieving points between the pipeline and a base. It may be, but is not limited to, a pipeline that is used in a maritime environment, for example aboard an offshore drilling rig. Contact points between a pipeline, which may be very long and heavy, and the base are very vulnerable as far as corrosion is concerned. The base at the contact points may be subjected to severe concentrated loads and rubbing between the pipe body and the base, for example because of rough sea, resulting in wear on both the pipe body and the base. It is known to glue Teflon pads on at the contact point between the pipe body and the base, but this has turned out not to be a very durable solution as the Teflon pads have a tendency to fall off over time. Further, stagnant water and salt squeezed between the pipeline and the pipe support will increase the risk of crevice corrosion.

The patent document GB 2285667 A discloses a pipe support including a saddle fixed to a base. The saddle may be curved to be adapted to the shape of a pipe.

The patent document JP 11141742 defines a pipe support with a saddle plate of fibre-reinforced resin which is fixed to the pipe support to reduce the friction between the pipe support and a pipeline. The pipe support and the associated saddle plate are curved and formed with one cut-out at the bottom of the curve.

The patent document JP 11304054 defines a pipe support including a rectangular steel beam, wherein a spacer is placed between the steel beam and a pipeline, and wherein the pipeline is fixed to the spacer by means of an adhesive.

Known patent documents disclose pipe supports that have one or more drawbacks. Pipe supports without sufficient drainage between the pipe support and a pipeline will be unsuitable for use in a maritime environment because of the risk of corrosion. One drain opening at the bottom of the pipe support will not be sufficient to prevent corrosion in the entire contact area between a pipeline and the pipe support. Further, the patent documents do not indicate pipe supports with relieving elements that may easily, and without removing the pipeline, be replaced in connection with wear, or be temporarily removed in connection with an inspection of the pipeline.

The invention has for its object to remedy or reduce at least one of the drawbacks of the prior art or at least provide a useful alternative to the prior art.

The object is achieved through features which are specified in the description below and in the claims that follow.

A pipe support enabling safe relieving of a pipeline has been provided. A bracket is arranged to be fixed to a base at a contact point between the pipeline and the base. A relieving element is further attached to the bracket and formed in such a way that a pipeline may rest against the relieving element. The relieving element is formed with an arched surface with a curvature adapted to the pipeline to be relieved. The surface of the relieving element that the pipeline is resting against is additionally formed with a plurality of indentations so that the surface may have a wavy or castellated appearance. This is advantageous in that water and salt are easily carried away from the pipe support and that the risk of crevice corrosion is reduced. With advantage, the relieving element may be replaceable. Often, several pipe supports in accordance with the invention will be used, maybe approximately equally spaced, to relieve a long, heavy pipe.

The invention relates, more specifically, to a pipe support device for relieving a pipeline, the pipe support including:
a bracket arranged to be fixed to a base; and
a relieving element, the surface of the relieving element facing the pipeline in its position of application being formed with a radius of curvature adapted to the outer radius of curvature of the pipeline, characterized by the curved surface of the relieving element being formed with a plurality of recesses, whereby a plurality of slots is provided between the pipeline and the relieving element in the position of application of the relieving element.

In one embodiment, the relieving element may be releasably attached to the bracket.

This may be an advantage as the relieving element may be replaced, for example because of wear.

In a preferred embodiment, the recesses may be distributed across substantially the entire curved surface of the relieving element. This will be advantageous as clearances will be provided between the pipeline and the relieving element over substantially the entire contact area between them so that good drainage is ensured over the entire contact area.

In a further preferred embodiment, a central recess at the bottom of the relieving element may have a larger extent than the rest of the recesses. Particles and liquid will have a tendency to collect at the bottom of the relieving element. It may therefore be an advantage if the recess at the bottom is larger, to accommodate more. It will also be an advantage to have a larger recess at the bottom of the relieving element as access will be easier in a possible inspection of the bottom side of the pipeline.

It may further be an advantage if the relieving element is symmetrical around a plane extending normal to the plane of curvature of the relieving element and centrally through the bottom of the relieving element. This will ensure an even weight distribution on the relieving element from a pipeline.

In a preferred embodiment, the relieving element may be arranged to be released from the bracket by the relieving element being slid, in its position of application, along the pipeline. This will be very advantageous as the relieving element may be removed without having to remove the pipeline, whether that be for inspection of the bottom side of the pipeline or for replacing of the relieving element, for example owing to wear.

The relieving element may be formed from a multitude of different materials. They may be, for example, but are not limited to different polymer materials. In one possible embodiment, the relieving element may be formed, at least in part, from one of the following materials:

polyoxymethylene (POM);

polytetrafluorethylene (PTFE);

glass-filled polytetrafluorethylene;

nylon;

wood;

fibreglass (GRP); and

polypropylene.

This will have the effect of a pipeline, which will often be formed from metal, being protected from wear against the relieving element. It may also protect the possible painting of a painted pipe.

In one embodiment, the bracket may be provided with an end wall. This may prevent the relieving element from being displaced off the bracket. The relieving element may be attached to the end wall by means of threaded bolts or the like.

In another embodiment, the bracket may alternatively or additionally be provided with cheeks. The cheeks may support around the relieving element so that it cannot be displaced sideways off the bracket. The cheeks may also take lateral forces that would otherwise have been a load on the connection of the relieving element to the bracket, for example on the above-mentioned bolts.

A pipe support in accordance with the above description may thus be used to relieve any pipe.

In what follows, an example of a preferred embodiment is described, which is visualized in the accompanying drawings, in which:

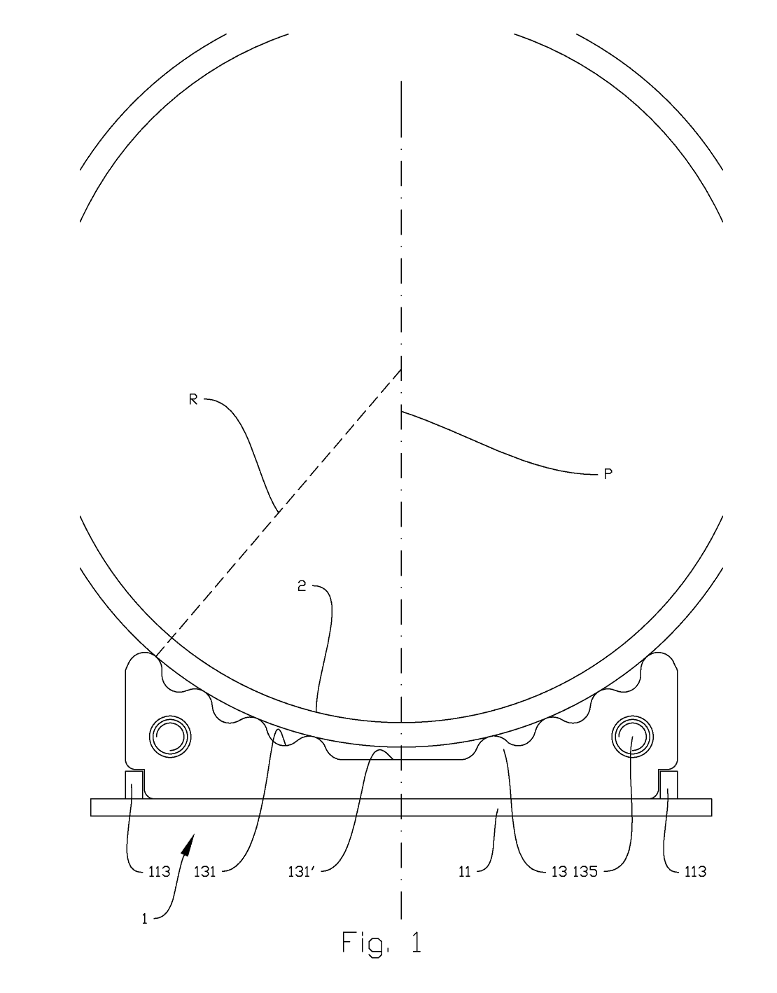

FIG. 1 shows a pipe support in accordance with the invention in a front view;

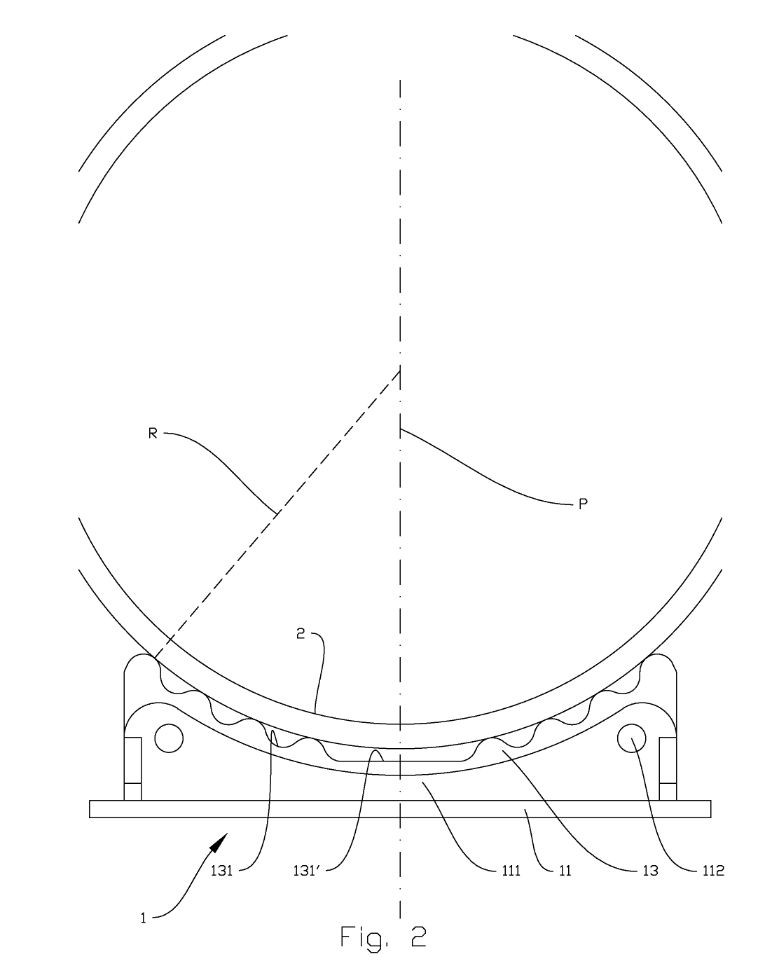

FIG. 2 shows a pipe support in accordance with the invention in a rear view;

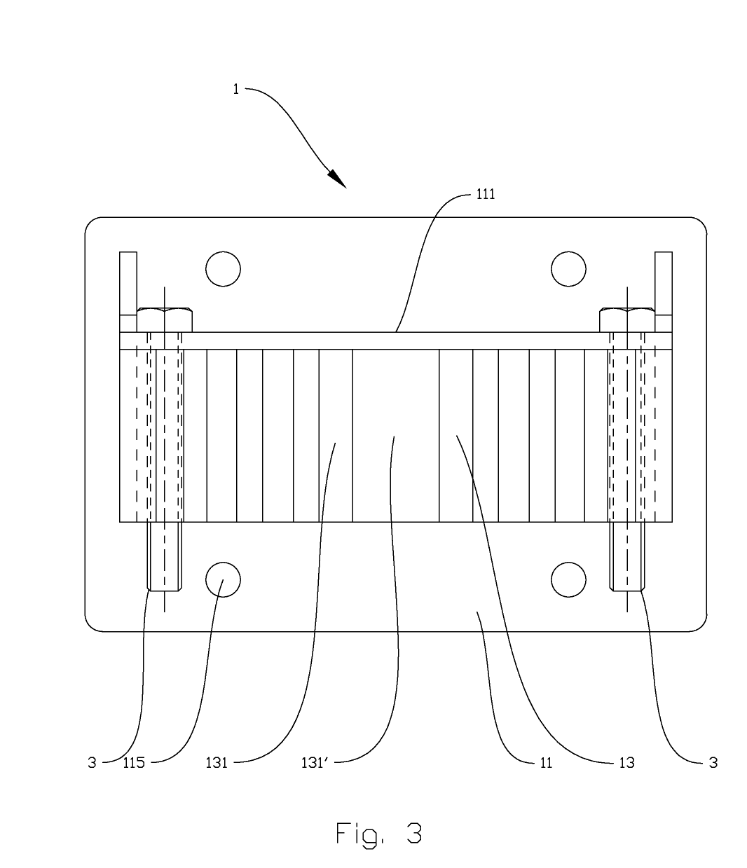

FIG. 3 shows a pipe support in accordance with the invention in a top view; and

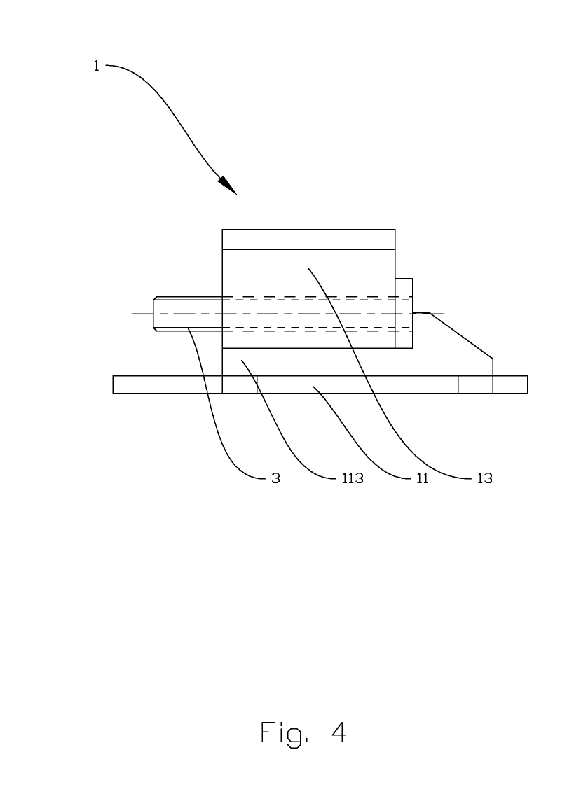

FIG. 4 shows a pipe support in accordance with the invention in a side view.

In what follows, the reference numeral 1 indicates a pipe support in accordance with the invention. The pipe support 1 includes a bracket 11 arranged to be attached to a base and a relieving element 13 arranged to be attached to the bracket 11.

FIG. 1 shows the pipe support 1 with a pipeline 2 resting in the relieving element 13, in a front view. The relieving element 13 is formed with a radius of curvature R substantially equal to the radius of curvature of the pipeline so that the weight load from the pipeline 2 is distributed as evenly as possible across the relieving element 13. The curved surface of the relieving element 13 is further formed with a plurality of recesses 131, 131′ so that the relieving element 13 presents a wavy surface. A central recess 131′ at the bottom of the relieving element is larger than the rest of the recesses 131 which are placed symmetrically around a plane P extending through the bottom of the relieving element 13 and normal to the plane of curvature of the relieving element 13, the plane of curvature corresponding to the paper plane of the figure. The relieving element 13 is further formed with bolt holes 135 for the attachment of the relieving element to the bracket 11. Two cheeks 113 on either side of the bracket 11 prevent the relieving element 13 from sliding sideways.

FIG. 2 shows the pipe support 1 in a rear view. An end wall 111 on the bracket 11 prevents the relieving element 13 from sliding backwards, that is to say out of the paper plane according to the figure. The end wall 111 is formed with bolt holes 112 corresponding to the bolt holes 135 of the relieving element 13.

FIG. 3 shows the pipe support 1 in a top view, without the pipeline 2 for the sake of exposition. The figure also shows a pair of bolts 3 attaching the relieving element 13 to the bracket 11 through the above-mentioned bolt holes 135, 112. The bolts 3 will typically be secured by means of nuts not shown. The figure also shows that the bracket 11 is formed with bolt holes 115 for fixing the bracket 11 to a base in a manner known per se.

FIG. 4 shows the pipe support 1 in a side view, without the pipeline 2 for the sake of exposition. The relieving element 13 may be released and removed from the bracket 11 by loosening said nuts, not shown, and possibly giving the pipeline 2 a small lift if necessary, in order then to slide the relieving element 13 off the bolts 3 and the bracket 11 parallel to the bolts 3, that is to say along the pipeline 2 as shown in FIGS. 1 and 2, out of and into the paper plane, respectively.

1. A pipe support device for relieving a pipeline, the pipe support comprising:
a bracket arranged to be fixed to a base; and
a relieving element, the surface of the relieving element facing the pipeline the position of application being formed with a radius of curvature adapted to the outer radius of curvature of the pipeline, and the curved surface of the relieving element being formed with a plurality of recesses whereby a plurality of slots is provided between the pipeline and the relieving element in the position of application of the relieving element, wherein
the relieving element is provided as one unit; and
the bracket is provided with cheeks.

2. The device in accordance with claim 1, wherein the relieving element is releasably attached to the bracket.

3. The device in accordance with claim 1, wherein the recesses are distributed across substantially the entire curved surface of the relieving element.

4. The device in accordance with claim 1, wherein a central recess at the bottom of the relieving element has a larger extent than the rest of the recesses.

5. The device in accordance with claim 1, wherein the relieving element is symmetric around a plane extending normal to the plane of curvature of the relieving element and centrally through the bottom of the relieving element.

6. The device in accordance with claim 1, wherein the relieving element is arranged to be released from the bracket by the relieving element being slid, in its position of application, along the pipeline.

7. The device in accordance with claim 1, wherein the relieving element is formed, at least in part, from one of the following materials:
polyoxymethylene (POM);
polytetrafluorethylene (PTFE);
glass-filled polytetrafluorethylene;
nylon;
wood;
fibreglass (GRP); and
polypropylene.

8. The device in accordance with claim 1, wherein the bracket is provided with an end wall.

9. A pipeline relieved by a pipe support comprising:
a bracket arranged to be fixed to a base; and
a relieving element, the surface of the relieving element facing the pipeline in the position of application being formed with a radius of curvature adapted to the outer radius of curvature of the pipeline, and the curved surface of the relieving element being formed with a plurality of recesses, whereby a plurality of slots is provided between the pipeline and the relieving element in the position of application of the relieving element, wherein
the relieving element is provided as one unit; and
the bracket is provided with cheeks.
